(19) United States
(12) Patent Application Publication
(10) Pub. No.: US 2026/0099887 A1
(43) Pub. Date: Apr. 9, 2026

(54) INFORMATION PROCESSING DEVICE, SELECTION METHOD OF HARVEST RANGE, AND COMPUTER PROGRAM

(71) Applicant: Kubota Corporation, Osaka (JP)

(72) Inventors: Masahito NAMBU, Sakai-shi (JP); Hirokazu SASAMOTO, Sakai-shi (JP); Satoshi TANAKA, Sakai-shi (JP)

(21) Appl. No.: 19/405,828

(22) Filed: Dec. 2, 2025

Related U.S. Application Data
(63) Continuation of application No. PCT/JP2024/018728, filed on May 21, 2024.

(30) Foreign Application Priority Data
Jun. 28, 2023 (JP) 2023-106294

(51) Int. Cl. G06Q 50/02; G06Q 10/0631; G06Q 30/0202

(52) U.S. Cl. CPC G06Q 50/02; G06Q 10/063112; G06Q 30/02024

(57) ABSTRACT

An information processing device includes a storage to store value data representing a crop value of a crop for each planting position, and a controller configured or programmed to execute selection processing of a harvest range based on the value data, in which the selection processing includes processing of calculating a harvestable area in which a work subject is allowed to execute harvesting in a predetermined period, and processing of allocating the harvestable area to the planting position where the crop value is equal to or more than a predetermined threshold.

### CROSS REFERENCE TO RELATED APPLICATIONS

This application claims the benefit of priority to Japanese Patent Application No. 2023-106294 filed on Jun. 28, 2023 and is a Continuation Application of PCT Application No. PCT/JP2024/018728 filed on May 21, 2024. The entire contents of each application are hereby incorporated herein by reference.

### BACKGROUND OF THE INVENTION

### 1. Field of the Invention

The present disclosure relates to information processing devices, selection methods of harvest ranges, and non-transitory computer-readable media including computer programs.

### 2. Description of the Related Art

WO 2018/158821 A describes an information proposal system that proposes a harvest time and a yield of a crop based on a predicted sales price of the crop in a market and a growth state of the crop obtained from image analysis.

Japanese Laid-Open Patent Publication No. 2013-254356 describes an agricultural management support system that efficiently allocates workers that perform work and equipment in a plurality of farm fields located at distant positions from previously registered workers and equipment.

### SUMMARY OF THE INVENTION

An information processing device according to an example embodiment of the present disclosure includes a storage to store value data representing a crop value of a crop for each planting position, and a controller configured or programmed to execute selection processing of a harvest range based on the value data, in which the selection processing includes processing of calculating a harvestable area in which a work subject is allowed to execute harvesting in a predetermined period, and processing of allocating the harvestable area to the planting position where the crop value is equal to or more than a predetermined threshold.

Example embodiments of the present invention can be implemented by a device, a system, a method, an integrated circuit, a computer program, a computer-readable non-transitory recording medium, or any combination thereof.

The properties of the recording medium may be either volatile or nonvolatile. The device may include a plurality of individual devices. In the case of a configuration including a plurality of individual devices, the devices may be arranged in one housing, or may be arranged separately in two or more separate housings.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a network configuration diagram illustrating an overall configuration of a work support system.

FIG. 2 is a block diagram illustrating a configuration example of a management server.

FIG. 3 is an explanatory diagram illustrating an example of selection processing of a harvest range.

FIG. 4 is an explanatory diagram illustrating an example of generation processing of an achievement characteristic.

FIG. 5 is a sequence diagram illustrating a use example of selection processing in a work plan.

FIG. 6 is a diagram illustrating an example of a display screen of a selection result in the management terminal.

FIG. 7 is a sequence diagram illustrating a first use example of an achievement characteristic in a work plan.

FIG. 8 is a sequence diagram illustrating a second use example of an achievement characteristic in a work plan.

FIG. 9 is an explanatory diagram illustrating an example of a prediction method of future growth data.

### DETAILED DESCRIPTION OF THE EXAMPLE EMBODIMENTS

In WO 2018/158821 A and Japanese Laid-Open Patent Publication No. 2013-254356, a harvest range selection method for appropriately distributing labor force of a work subject according to the crop value when a crop is harvested is not assumed.

In view of such conventional problems, example embodiments of the present disclosure enable appropriate allocation of labor force of a work subject.

According to example embodiments of the present disclosure, labor force of a work subject can be appropriately allocated.

Hereinafter, an outline of example embodiments of the present disclosure will be listed and described.

(1)An information processing device according to an example embodiment of the present disclosure includes a storage to store value data representing a crop value of a crop for each planting position, and a controller configured or programmed to execute selection processing of a harvest range based on the value data, in which the selection processing includes processing of calculating a harvestable area in which a work subject is allowed to execute harvesting in a predetermined period, and processing of allocating the harvestable area to the planting position where the crop value is equal to or more than a predetermined threshold.

With the information processing device of the present example embodiment, since the controller allocates the harvestable area to the planting position where the crop value is equal to or more than the predetermined threshold, the planting position where the crop value is less than the threshold is excluded from the allocation target, and the harvest work of the crop having a low crop value can be avoided. Therefore, the labor force of the work subject can be appropriately allocated.

(2)In an information processing device of an example embodiment of the present disclosure, the selection processing may include processing of preferentially allocating the harvestable area to the planting position having a high crop value.

In this case, since the planting position having the highest crop value is included in the harvest range, crops having a high crop value can be harvested early.

(3)In an information processing device of an example embodiment of the present disclosure, the selection processing may include processing of arbitrarily selecting a first planting position as the planting position, and preferentially allocating second and subsequent planting positions that are close in distance from the first planting position.

In this case, since the allocation target is determined based on the distance in the second and subsequent planting positions, it is possible to select the harvest range in which the movement distance of the work subject is short.

(4)In an information processing device of an example embodiment of the present disclosure, the selection processing may include processing of calculating the harvestable area based on a harvest time during which the work subject is allowed to execute harvesting, harvest efficiency of the work subject, and a total number of the work subjects.

In this manner, the harvestable area can be accurately calculated according to the labor force that can be input during the predetermined period.

(5)In an information processing device of an example embodiment of the present disclosure, the storage may be configured to store growth data indicating a growth degree of the crop for each of the planting positions, and the controller may be configured or programmed to execute processing of converting the growth data into the value data.

In this case, since the value data is generated from the actual growth data, the value data can be accurately generated.

(6)In an information processing device of an example embodiment of the present disclosure, the controller may be configured or programmed to output the value data including the harvest range that has been selected as a selection result.

In this case, for example, by displaying the output selection result (value data including the harvest range) on the display, the user can determine at a glance from where in the farm field the harvest work should be performed.

(7)In an information processing device of an example embodiment of the present disclosure, the controller may be configured or programmed to execute calculation processing of an achievement characteristic indicating a relationship between a high value yield and a harvest achievement, wherein the high value yield is a yield when harvest work is performed in descending order of crop values and the harvest achievement is a cumulative value of crop values when harvest work is performed in descending order of crop values.

In this case, in addition to the above-described harvest range, it is possible to acquire the above-described achievement characteristics indicating characteristics of a harvest achievement with respect to a high value yield.

(8)In an information processing device of an example embodiment of the present disclosure, the controller may be configured or programmed to calculate a harvestable amount that is a yield of the crop that is achievable during the predetermined period, and calculate a possible harvest achievement that is the harvest achievement corresponding to the harvestable amount based on the harvestable amount and the achievement characteristic.

In this case, by notifying the user of the calculation result, it is possible to notify the user in advance of the maximum harvest achievement obtained with the currently available labor force.

(9)In an information processing device of an example embodiment of the present disclosure, the controller may be configured or programmed to acquire a target harvest achievement that is the harvest achievement desired by a user, and calculate a target yield that is the high value yield corresponding to the target harvest achievement based on the target harvest achievement and the achievement characteristic.

In this case, by notifying the user of the calculation result, it is possible to notify the user in advance of the high value yield necessary for achieving the desired harvest achievement.

(10)A selection method according to an example embodiment of the present disclosure is a method of selecting a harvest range executed by the information processing device of (1) to (9) described above.

Therefore, the selection method of the present example embodiment has the same effects as those of the information processing device (1) to (9) described above.

(11)A non-transitory computer readable storage medium storing a computer program according to the present example embodiment, wherein the computer program causes a computer to function as the information processing device of (1) to (9) described above.

Therefore, the non-transitory computer readable storage medium storing a computer program of the present example embodiment has the same functions and effects as those of the information processing device of (1) to (9) described above.

Hereinafter, example embodiments of the present disclosure will be described in detail with reference to the drawings. Note that at least some of the example embodiments described below may be arbitrarily combined.

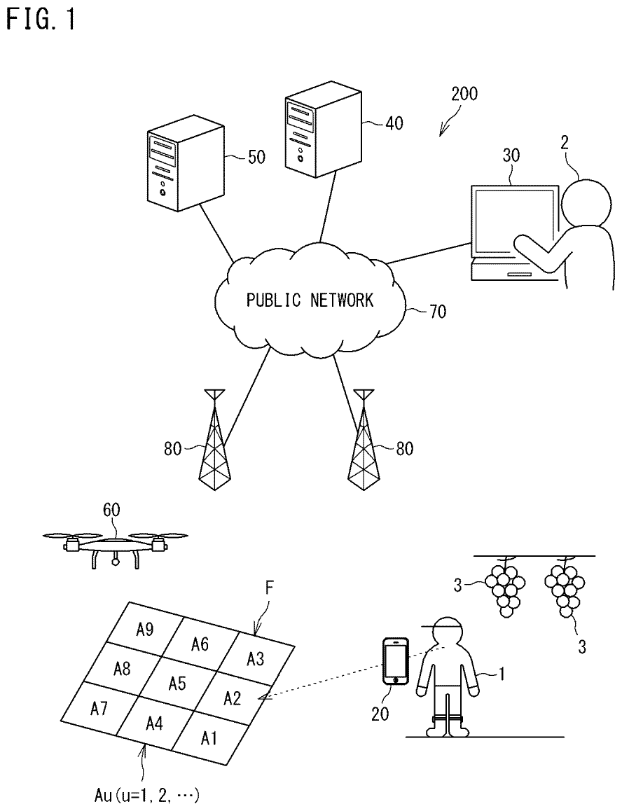

FIG. 1 is a network configuration diagram illustrating an overall configuration of a work support system 200.

A work support system (hereinafter, also referred to as a “support system”) 200 in FIG. 1 is a system in which a mobile terminal 20, a management terminal 30, and a management server 40 cooperate to support farmwork performed by the worker 1. Therefore, the support system 200 includes at least the mobile terminal 20, the management terminal 30, and the management server 40 as communication nodes that exchange information.

The mobile terminal 20, the management terminal 30, and the management server 40 are connected by a public network 70 including the Internet and the like. However, the mobile terminal 20 is connected to the public network 70 via radio communication with a radio base station 80.

The mobile terminal 20 is a communication terminal assigned to the worker 1. The mobile terminal 20 is, for example, a smartphone, a tablet computer, a notebook computer, or the like. In the illustrated example, only one worker 1 is illustrated, but a plurality of workers 1 may be illustrated.

The management terminal 30 is a terminal device assigned to a management person (hereinafter, the user is referred to as a “management user”) 2 of the farm F including a plurality of farm fields Au (u=1, 2, . . . ). In the illustrated example, one farm F includes nine farm fields Au, but the number of farm fields Au is arbitrary and only needs to be one or more.

The management terminal 30 is, for example, a desktop computer. The management terminal 30 may be a mobile terminal such as a smartphone, a tablet computer, or a laptop computer.

The management user 2 is a user of an agricultural work support service provided by the management server 40. The management user 2 is registered as a member in advance in the management server 40.

The farm fields Au of the present example embodiment are, for example, vineyards for cultivating grapes 3 to be a raw material of wine. In the vineyards Au, grapes 3 of the same variety or grapes 3 of different varieties are cultivated.

In addition to the mobile terminal 20 and the management terminal 30, the management server 40 communicates with external devices such as an information provision server 50 and a flying device 60. The flying device 60 is connected to the public network 70 via radio communication with the radio base station 80.

The agricultural work support service of the management server 40 includes a service for providing the user with a work plan related to the farmwork of the vineyard Au. The management server 40 creates a work plan based on predetermined input information received from the management terminal 30.

The “work plan” is a data group that defines a schedule (information including the contents of 5W1H) of work in the near future performed by the worker 1 in the vineyard Au. Examples of the farmwork of the vineyard Au include pruning, bud removal, training, gibberellin treatment, pinching, bagging, and harvesting.

When accessing the agricultural work support service of the management server 40, the management terminal 30 can transmit a creation request based on an input operation of the management user 2 to the management server 40. The creation request includes predetermined information (for example, the number of workers, a working time zone, and the like) necessary for the work plan creation processing.

The management server 40 creates a work plan of the vineyard Au in response to a creation request from the management terminal 30, and transmits the created work plan to the management terminal 30.

In addition, the management server 40 transmits work content of the worker 1 based on the created work plan to the mobile terminal 20 of each worker 1. However, the management terminal 30 may notify each mobile terminal 20 of the work content.

The information provided by the information provision server 50 includes growth data of the vineyard Au. The management server 40 can receive the growth data from the information provision server 50. The growth data is data indicating a “growth degree” of a crop (for example, grape 3) for each planting position.

As the growth degree, for example, a vegetation index such as normalized difference vegetation index (NDVI) can be adopted. NDVI is an index that expresses the status of vegetation with a relatively simple calculation formula based on the reflection characteristics of light of the plant.

The flying device 60 is, for example, a robot flying object such as a quadcopter or a multicopter. The flying device 60 is capable of flying over any area by remote control and includes a digital camera capable of switching an imaging direction.

When capturing the vineyard Au from above with the digital camera, the flying device 60 transmits the acquired image data to the management server 40. The management server 40 can also generate some or all of the growth data of the vineyard Au by itself using the received image data.

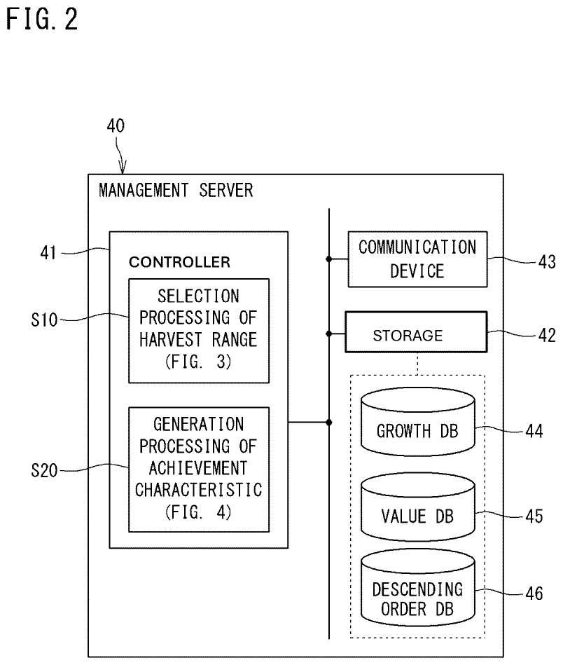

FIG. 2 is a block diagram illustrating a configuration example of the management server 40.

As illustrated in FIG. 2, the management server 40 is a type of information processing device including a controller 41, a storage 42, a communication device 43, and a plurality of types of databases (DBs) 44 to 46.

The plurality of types of databases 44 to 46 is electronic data constructed in a predetermined data array in the storage 42. Note that a part or all of the databases 44 to 46 may be constructed in an external storage (not illustrated) connected to the management server 40.

The controller 41 may be an arithmetic processing device including a central processing unit (CPU), a random access memory (RAM), and the like. The controller 41 may include an integrated circuit such as a field-programmable gate array (FPGA).

The controller 41 reads the computer program 47 stored in the storage 42 into a main memory (RAM), and executes information processing according to the read program 47. The information processing includes creation of a work plan, generation of growth data, and the like.

The storage 42 is an auxiliary storage including a non-volatile memory such as a hard disk drive (HDD) and a solid state drive (SSD).

The storage 42 may include a flash read only memory (ROM), a universal serial bus (USB) memory, an SD card, or the like. The communication device 43 is a communication interface capable of communicating with an external device via the public network 70.

The plurality of types of databases 44 to 46 includes a growth database 44, a value database 45, and a descending order database 46.

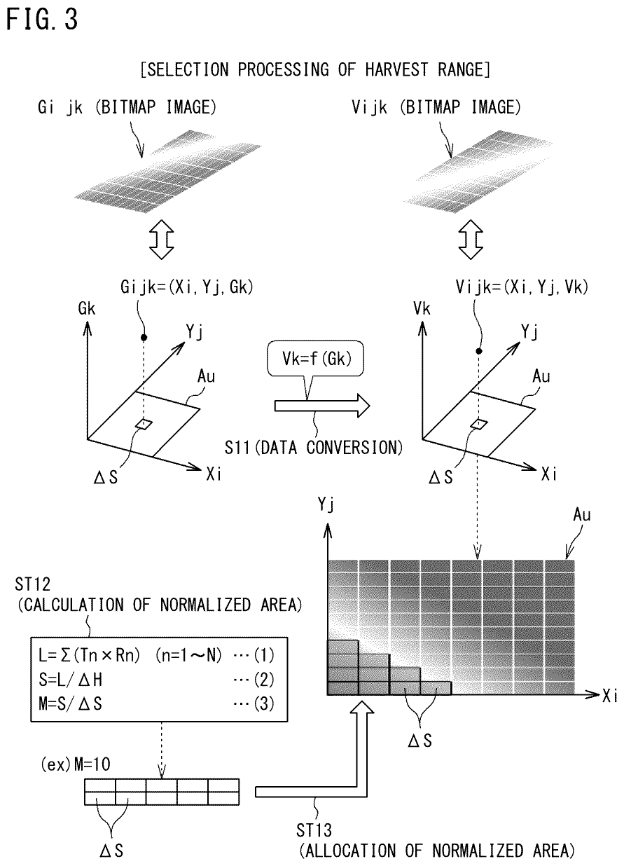

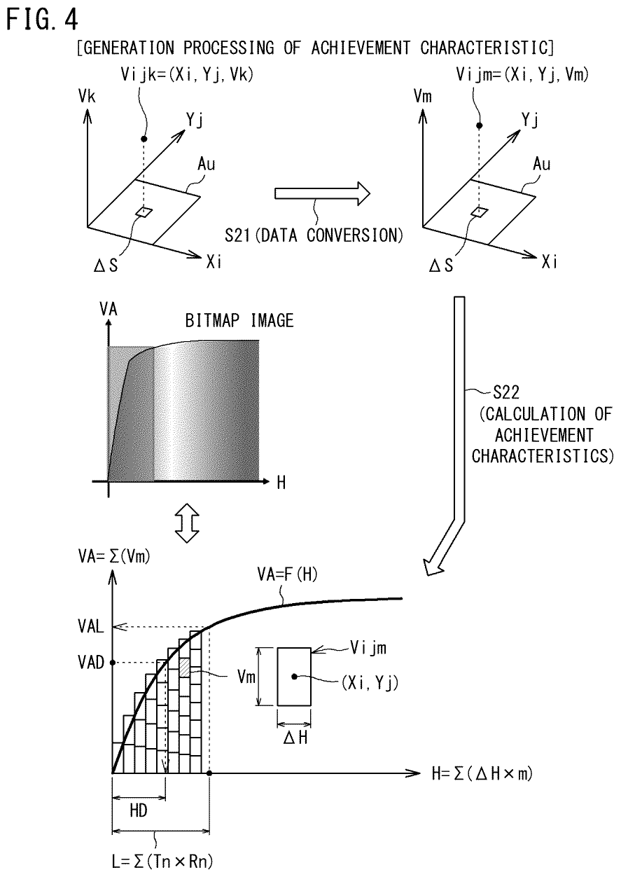

The growth database 44 stores growth data Gijk (see FIG. 3). Value data Vijk (see FIG. 3) is stored in the value database 45. The descending order database 46 stores descending order data Vijm (see FIG. 4). Details of these pieces of data Gijk, Vijk, and Vijm will be described later.

The computer program 47 includes a program for causing the controller 41 to execute “selection processing of a harvest range” (step S10: see FIG. 3) and “generation processing of an achievement characteristic” (step S20: see FIG. 4) as processing accompanying the work plan creation processing.

The selection processing of a harvest range is processing of selecting a harvest range for the vineyard Au based on the value data Vijk. The generation processing of an achievement characteristic is processing of generating an achievement characteristic F indicating a characteristic of an achievement (a cumulative value of values) with respect to a yield based on the value data Vijk.

FIG. 3 is an explanatory diagram illustrating an example of selection processing of a harvest range executed by the controller 41 of the management server 40. Hereinafter, the definition of the parameter used for the selection processing of the harvest range will be described, and then the content of the selection processing will be described.

### (Xi, Yj): Planting Position

The planting position (Xi, Yj) is, for example, the location of the trunk of the tree of grape 3, and is defined by an absolute coordinate system such as latitude and longitude or a relative coordinate system based on a predetermined position.

The planting position (Xi, Yj) may be a point (for example, a center of gravity point) representing a location of a trunk of a plurality of trees. “Xi” is a position in the X direction (i is an identification number of a coordinate value in the X direction), and “Yj” is a position in the Y direction (j is an identification number of a coordinate value in the Y direction).

### Gk: Growth Degree

Growth degree Gk is an index representing the degree of growth of the grape 3. The growth degree is a vegetation index such as NDVI. “k” is an identification number of the value of the growth degree and the next crop value.

### Vk: Crop Value

Crop value Vk is an index representing the value of the grape 3 at the present time. As the index, for example, a sales price per unit weight of the grape 3, a component value of the grape 3, and the like can be adopted. As the component value, at least one of sugar content, acidity, or a pH value may be employed.

### Gijk: Growth Data

Growth data Gijk is data representing the growth degree Gk of the grape 3 for each planting position (Xi, Yj). The growth data Gijk is defined by the following three-dimensional vector.

### Gijk=(Xi, Yj, Gk)

The data format of the growth data Gijk may be either a digital map format or a table format. Growth data in a digital map format is referred to as a “growth map”. In a case where the growth map is displayed on the display, for example, as illustrated in FIG. 3, the growth map can be displayed as a bitmap image in which the size of the growth degree Gk is expressed by color, shade, or the like.

### Vijk: Value Data

The value data Vijk is data representing the crop value Vk for each planting position (Xi, Yj). The value data Vijk is defined by the following three-dimensional vector.

### Vijk=(Xi, Yj, Vk)

The data format of the value data Vijk may be either a digital map format or a table format. Note that the value data in the digital map format is referred to as a “value map”. In a case where the value map is displayed on the display, for example, as illustrated in FIG. 3, the value map can be displayed as a bitmap image representing the size of the crop value Vk by color, shade, or the like.

### ΔS: Unit Area (m²)

Unit area ΔS is an area having a predetermined shape having a unit area including a planting position (Xi, Yj). The shape of the area is preferably, for example, a rectangle, but may be a shape other than a rectangle such as an ellipse or a hexagon. The unit area of the area can be set in advance according to the planting interval of the trees of the grapes 3 and the like.

### ΔH: Unit Yield (kg/m²)

Unit yield ΔH is the expected yield (kg/m²) of the grape 3 in the unit area ΔS. The unit yield ΔH can be set in advance according to a statistical value (for example, an average value or a median value) of the number of grapes 3 grown on trees included in the unit area ΔS. In addition, the unit yield ΔH may be set to a different value for each variety of the grape 3.

### Tn: Harvest Time (h)

Harvest time Tn is a time during which the worker 1 can perform harvest in a predetermined period (for example, one day to one week). “n” is an identification number of the worker 1.

The harvest time Tn can be set to a different value for each worker 1 according to, for example, a future working time zone adjusted by the management user 2 with each worker 1.

### Rn: Harvest Efficiency (kg/h)

Harvest efficiency Rn is a yield that can be harvested by the worker 1 per unit time.

The harvest efficiency Rn can be set to a different value for each worker 1 according to the skill level of each worker, for example, by the management user 2. The harvest efficiency Rn may be set to a different value for each variety.

### L: Harvestable Amount (kg)

The harvestable amount L is a yield of the grape 3 that can be obtained in a predetermined period (for example, one day to one week). The harvestable amount L is defined by the following formula.

$$L = Σ ( Tn \times Rn ) ( n = 1 to N ) \qquad ( 1 )$$

However, “N” is the total number of workers 1 who can be mobilized during a predetermined period.

### S: Harvestable Area (m²)

Harvestable area S is an area where the worker 1 can execute harvesting in a predetermined period (for example, one day to one week). The harvestable area S is defined by the following formula.

$$S = L / Δ H \qquad ( 2 )$$

### M: Normalized Area (Pieces)

Normalized area M is a conversion value in a case where the harvestable area S is normalized by the number of unit areas ΔS. The normalized area M is defined by the following formula.

$$M = S / Δ S = ( L / Δ H ) / Δ S \qquad ( 3 )$$

As illustrated in FIG. 3, the harvest range selection processing (step S10 in FIG. 2) includes the following processing.
Step S11: Data conversion
Step S12: Calculation of normalized area
Step S13: Allocation of normalized area

### Data Conversion: Step S11

The data conversion is processing of converting the growth data Gijk into the value data Vijk.

Specifically, the data conversion is processing of converting the growth degree Gk of the growth data Gijk into the crop value Vk using a predetermined conversion formula (Vk=f (Gk)). The predetermined conversion formula is, for example, an approximate formula representing a correlation between the growth degree Gk and the crop value Vk. The approximate formula is defined in advance according to the type of the crop value Vk based on, for example, past statistical data.

### Calculation of Normalized Area: Step S12

Calculation of the normalized area M is processing of calculating the normalized area M using the above-described Formulas (1) to (3). Specifically, the calculation of the normalized area M includes the following procedure.

Procedure 1: The harvestable amount L is calculated using Formula (1).

In the input information of Formula (1), the harvest time Tn and the total number N are notified by the management terminal 30. The harvest efficiency Rn of the worker 1 is a setting value registered in advance in the storage 42 of the management server 40.

Procedure 2: The harvestable area S is calculated using Formula (2).

The unit yield ΔH which is the input information of Formula (2) is a setting value registered in advance in the storage 42 of the management server 40.

Procedure 3: The normalized area M is calculated using Formula (3).

The unit area ΔS which is the input information of Formula (3) is a setting value registered in advance in the storage 42 of the management server 40.

### Allocation of Normalized Area: Step S13

The allocation of the normalized area M is processing of allocating the normalized area M corresponding to the harvestable area S calculated in step S12 to the planting position (Xi, Yj) of the value data Vijk based on a predetermined allocation logic. As the predetermined allocation logic, for example, the following logic can be adopted.

### Logic 1:

The unit area ΔS of the planting position (Xi, Yj) where the working value Vk is equal to or more than the predetermined threshold THv is set as an allocation target. The threshold THv is registered in advance in the storage 42 of the management server 40 for each type of the crop value Vk by the management user 2, for example.

When logic 1 is adopted, the unit area Δ that does not satisfy the crop value Vk desired by the management user 2 is excluded from the allocation target. Thus, the harvest work of the grape 3 having a low crop value Vk is avoided. Therefore, the labor force of the worker 1 can be appropriately allocated.

### Logic 2:

Among the unit areas ΔS of the planting position (Xi, Yj) where the working value Vk is equal to or more than the threshold THv, the unit area Δ of the planting position (Xi, Yj) where the crop value Vk is high is preferentially set as the allocation target.

When logic 2 is adopted, since the planting position (Xi, Yj) having the highest crop value Vk is included in the harvest range, the grape 3 having the high crop value Vk can be harvested early.

### Logic 3:

Any unit area ΔS is first selected from the unit areas ΔS of the planting positions (Xi, Yj) where the working value Vk is equal to or more than the threshold THv, and from the second and subsequent unit areas, the unit area ΔS having a short distance from the first unit area ΔS is preferentially set as the allocation target.

When logic 3 is adopted, since the allocation target is determined based on the distance from the second time on, it is possible to select the harvest range in which the movement distance of the worker 1 is short.

In the example of FIG. 3, value data (value map) Vijk is illustrated in which the value of the normalized area M is “10”, and the crop value Vk increases as it is closer to the origin of the vineyard Au.

In this case, for example, when the above-described logic 1 is applied, the harvest range including the 10 unit areas ΔS is assigned in a right triangle shape with the origin of the farm field Au as a right angle point.

FIG. 4 is an explanatory diagram illustrating an example of generation processing of an achievement characteristic executed by the controller 41 of the management server 40. Hereinafter, the definition of the parameter used for the generation processing of the achievement characteristic will be described, and then the content of the generation processing will be described. However, the description of the parameters described above is omitted.

### Vm: Descending Order Value

The descending order value Vm is data obtained by rearranging the values of the crop values Vk in descending order. “m” is an identification number of the value of the descending order value.

### Vijm: Descending Order Data

The descending order data Vijm is data representing the descending order value Vm at the planting position (Xi, Yj). The descending order data Vijm is defined by the following three-dimensional vector.

### Vijm=(Xi, Yj, Vm)

The data format of the descending order data Vijm may be either a digital map format or a table format. Note that the descending order data in the digital map format is referred to as a “descending order map”.

### H: High Value Yield (kg)

The high value yield H is a yield when the harvest work is performed in descending order of value of the grape 3, that is, a yield when the harvest work is performed from the unit area ΔS having a high descending order value Vm. The high value yield H is defined by the following formula.

$$H = Σ ( Δ H \times m ) ( m = 1 , 2 … ) \qquad ( 4 )$$

### VA: Harvest Achievement

Harvest achievement VA is a cumulative value of values in a case where the harvest work is performed in descending order of value of the grape 3, that is, an integrated value of the descending order value Vm in a case where the harvest work is performed from the unit area ΔS in which the descending order value Vm is high. The harvest achievement VA is defined by the following formula:

$$V A = Σ ( V m ) ( m = 1 , 2 … ) \qquad ( 5 )$$

### F: Achievement Characteristics

The achievement characteristic F is a parameter representing a characteristic of an achievement (cumulative value of values) with respect to the yield of the grape 3. In the present example embodiment, the achievement characteristic F is defined as a function representing the relationship between the high value yield H and the harvest achievement VA. That is, the achievement characteristic F is a function defined by the following formula.

$$V A = F ( H ) \qquad ( 6 )$$

In a case where the graph of the achievement characteristic F is displayed on the display, for example, as illustrated in FIG. 4, the graph can be displayed as a bitmap image in which the magnitude of the descending order value Vm used for the calculation of the achievement characteristic F is expressed by color, shade, or the like.

As illustrated in FIG. 4, the generation processing of the achievement characteristic (step S20 in FIG. 2) includes the following processing.

### Step S21: Data Conversion

Step S22: Calculation of achievement characteristics

### Data Conversion: Step S21

The data conversion is processing of converting the value data Vijk into the descending order data Vijm. Specifically, the data conversion includes the following procedure.

Procedure 1: The value data Vijk is arranged in descending order of the values of the crop values Vk.

Procedure 2: The identification number k is replaced with an identification number m to generate a descending order value Vm.

Procedure 3: Data including the descending order value Vm for each planting position (Xi, Yj) is defined as descending order data Vijm.

### Calculation of Achievement Characteristics: Step S22

The calculation of the achievement characteristic F is processing of calculating the achievement characteristic F of the vineyard Au using the descending order value Vm obtained in step S21. Specifically, the calculation of the achievement characteristic F includes the following steps.
Step 1: The identification number m of the descending order value Vm is set to an initial value (=1).
Step 2: The high value yield H is calculated using Formula (4).
Step 3: The harvest achievement VA is calculated using Formula (5).
Step 4: The calculated value of H and the calculated value of VA are plotted on an orthogonal coordinate in which the horizontal axis is H and the vertical axis is VA.
Step 5: The identification number m is incremented, and steps 2 to 4 are repeated.
Step 6: When the identification number m reaches the final value, the plotting is ended.
Step 7: A line obtained by connecting adjacent points of the plotted point group by a straight line or a curve is defined as an achievement characteristic F of Formula (6). Note that, in a case where an abnormal value is included in either the calculated value of H or the calculated value of VA, the complement processing may be performed by excluding the abnormal value.

Harvest characteristic F of FIG. 4 can be used for the following calculation processing.

### Calculation Processing 1: Calculation of “Possible Harvest Achievement VAL”

Calculation processing 1 is processing of calculating a harvest achievement VA with respect to the harvestable amount L in the achievement characteristic F. Hereinafter, the harvest achievement VA with respect to the harvestable amount L is referred to as a “possible harvest achievement VAL”. Specifically, the possible harvest achievement VAL is calculated by the following Formula (7).

$$VAL = F ( L ) \qquad ( 7 )$$

### Calculation Processing 2: Calculation of “Target Yield HD”

The calculation processing 2 is processing of calculating the high value yield H necessary for obtaining the harvest achievement VA desired by the management user 2 in the achievement characteristic F. Hereinafter, the desired harvest achievement VA is referred to as “target achievement VAD”, and the high value yield H necessary for this is referred to as “target yield HD”. Specifically, the target yield HD is calculated by the following Formula (8). Note that “F⁻¹” is an inverse function of the achievement characteristic F.

$$HD = {F}^{- 1} ( VAD ) \qquad ( 8 )$$

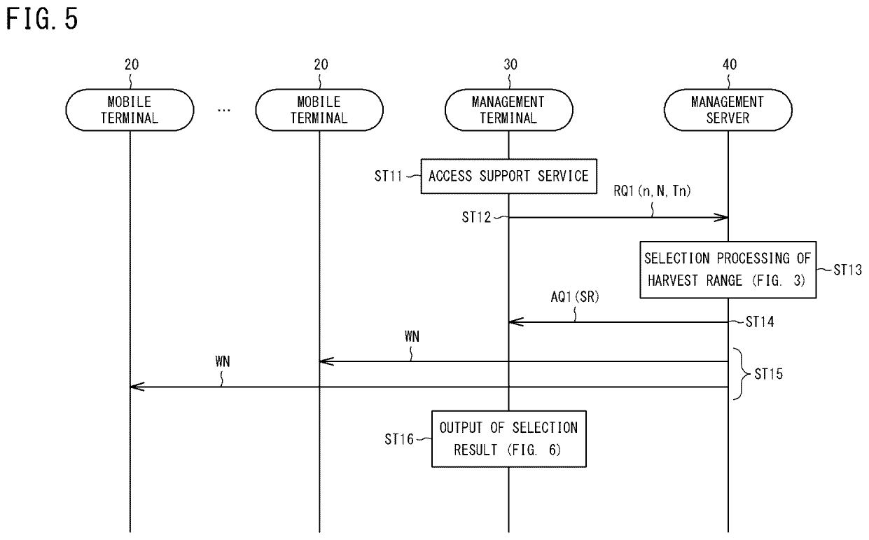

FIG. 5 is a sequence diagram illustrating a use example of the selection processing in the work plan.

As illustrated in FIG. 5, after accessing the support service (step ST11), the management terminal 30 transmits a work plan creation request RQ1 to the management server 40 (step ST12).

The creation request RQ1 includes the identification number n of the worker 1, the total number N, and the harvest time Tn of each worker 1. The identification number n can be determined from identification information such as the name of the worker 1.

Next, the management server 40 executes harvest range selection processing (step ST13).

Specifically, the controller 41 of the management server 40 selects the harvest range in the value data Vijk by executing the above-described selection processing (FIG. 3) using the received identification number n, total number N, and harvest time Tn as input information. In addition, the controller 41 outputs a selection result SR to the communication device 43. The selection result SR includes, for example, value data (value map) Vijk including the selected harvest range.

Next, the management server 40 transmits a creation response AQ1 including the selection result SR to the management terminal 30 (step ST14).

In addition, the management server 40 transmits the work content WN (for example, a harvest position, a time zone, and the like) for each worker 1 including the selection result SR to the mobile terminal 20 of each worker 1 (step ST15). However, the notification of the work content WN to each mobile terminal 20 may be performed by the management terminal 30.

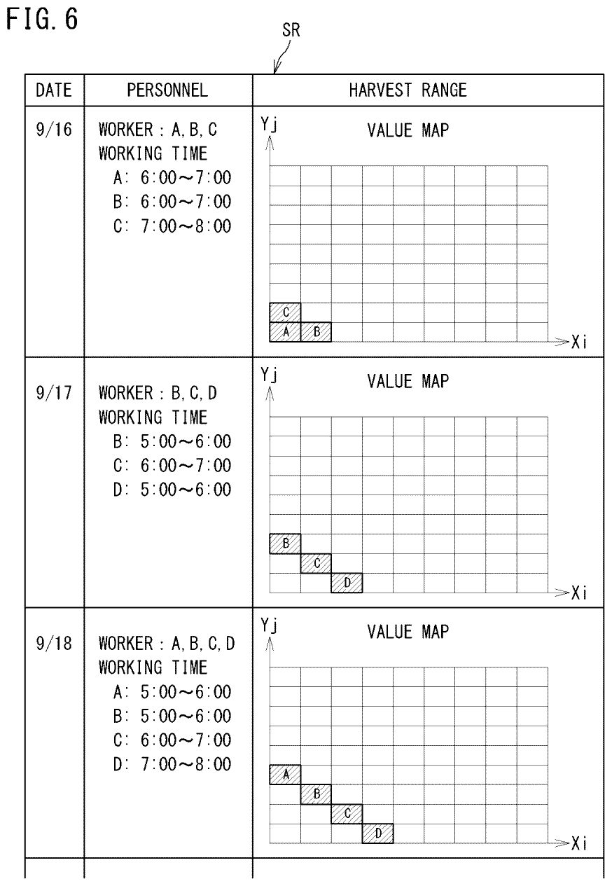

Next, the management terminal 30 outputs the selection result SR received from the management server 40 (step ST16). This output is, for example, processing of displaying the selection result SR on the display of the management terminal 30. FIG. 6 is a diagram illustrating an example of a display screen of the selection result SR in the management terminal 30.

As illustrated in FIG. 6, the display screen of the selection result SR includes fields of “date”, “personnel”, and “harvest range”.

In the fields of date and personnel, input information set by the management user 2 is written. In the illustrated example, the personnel on September 16 are workers A, B, and C (all are names), the personnel on September 17 are workers B, C, and D (all are names), and the personnel on September 18 are workers A, B, C, and D (all are names). In addition, it is assumed that the working time of the workers A, B, C, and D is as illustrated.

In the field of the harvest range, a value map Vijl including the harvest range selected by the selection processing (FIG. 3) is displayed. Note that the horizontal axis represents Xi and the vertical axis represents Yj.

In FIG. 6, as an example, the selection result SR of the harvest work in a case where the predetermined period is three days from September 16 to September 18 is illustrated. Specifically, the following harvest range (hatched portion in the drawing) is displayed as the harvest range to be executed in each schedule.
Harvest range for September 16
Planting position (X1, Y1)→worker A
Planting position (X2, Y1)→worker B
Planting position (X1, Y2)→worker C
Harvest range for September 17
Planting position (X1, Y3)→worker B
Planting position (X2, Y2)→worker C
Planting position (X3, Y1)→worker D
Harvest range for September 18
Planting position (X1, Y4)→worker A
Planting position (X2, Y3)→worker B
Planting position (X3, Y2)→worker C
Planting position (X4, Y1)→worker D

As illustrated in FIG. 6, if the selection result (harvest range) SR of the harvest range is superimposed and displayed on the value map Vijk of the farm field Au, the management user 2 can determine at a glance from where the harvest work should be performed in the vineyard Au, and a display mode with excellent visibility is obtained.

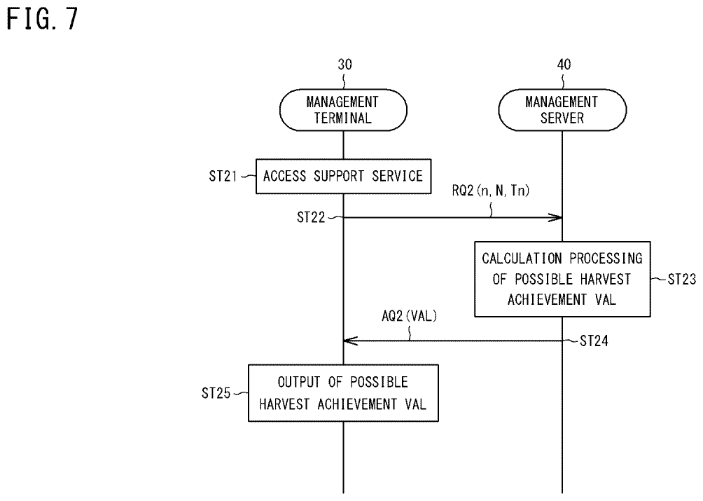

FIG. 7 is a sequence diagram illustrating a first use example of the achievement characteristic in the work plan.

As illustrated in FIG. 7, after accessing the support service (step ST21), the management terminal 30 transmits a calculation request RQ2 of a harvest achievement to the management server 40 (step ST22).

The calculation request RQ2 includes the identification number n of the worker 1, the total number N, and the harvest time Tn of each worker 1. The identification number n can be determined from identification information such as the name of the worker 1.

Next, the management server 40 executes calculation processing of the possible harvest achievement VAL (step ST23). Specifically, the controller 41 of the management server 40 calculates the harvestable amount L using the received identification number n, the total number N, and the harvest time Tn as input information.

In addition, the controller 41 calculates the possible harvest achievement VAL by applying the calculated harvestable amount L to Formula (7) regarding the achievement characteristic F.

Next, the management server 40 transmits a calculation response AQ2 including the possible harvest achievement VAL to the management terminal 30 (step ST24).

Next, the management terminal 30 outputs the possible harvest achievement VAL received from the management server 40 (step ST25). This output is, for example, processing of displaying the numerical value of the possible harvest achievement VAL itself or the graph of the achievement characteristic F including the numerical value of the possible harvest achievement VAL (see FIG. 4) on the display of the management terminal 30.

As described above, when the possible harvest achievement VAL which is the harvest achievement VA corresponding to the harvestable amount L in the achievement characteristic F is transmitted to the management terminal 30, it is possible to notify the management user 2 in advance of the maximum harvest achievement VA obtained by the currently available labor.

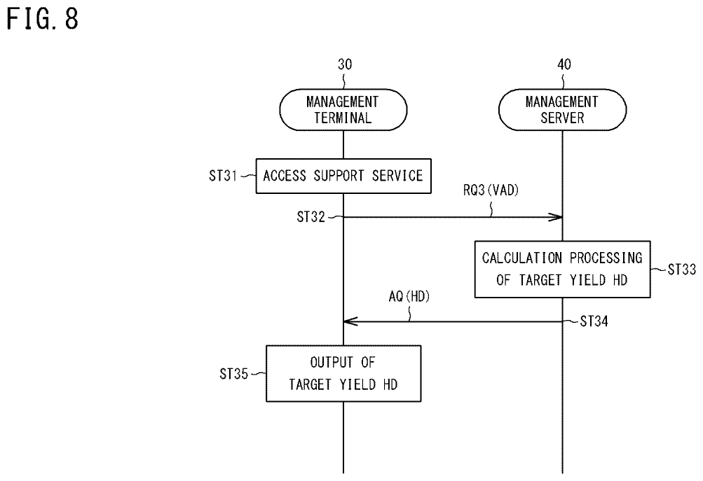

FIG. 8 is a sequence diagram illustrating a second use example of the achievement characteristic in the work plan.

As illustrated in FIG. 8, after accessing the support service (step ST31), the management terminal 30 transmits a yield calculation request RQ3 to the management server 40 (step ST32).

The yield calculation request RQ3 includes the target harvest achievement VAD which is the harvest achievement VA desired by the management user 2.

Next, the management server 40 executes calculation processing of the target yield HD (step ST33). Specifically, the controller 41 of the management server 40 calculates the target yield HD by applying the received target harvest achievement VAD to Formula (8) related to the inverse function of the achievement characteristic F.

Next, the management server 40 transmits a calculation response AQ3 including the target yield HD to the management terminal 30 (step ST34).

Next, the management terminal 30 outputs the target yield HD received from the management server 40 (step ST35). This output is, for example, processing of displaying the numerical value of the target yield HD itself or the graph of the achievement characteristic F including the numerical value of the target yield HD (see FIG. 4) on the display of the management terminal 30.

As described above, when the target yield HD which is the high value yield H corresponding to the target harvest achievement VAD in the achievement characteristic F is transmitted to the management terminal 30, it is possible to notify the management user 2 of the high value yield H necessary for achieving the desired harvest achievement VA in advance.

### Modification 1: Prediction Method of Growth Data

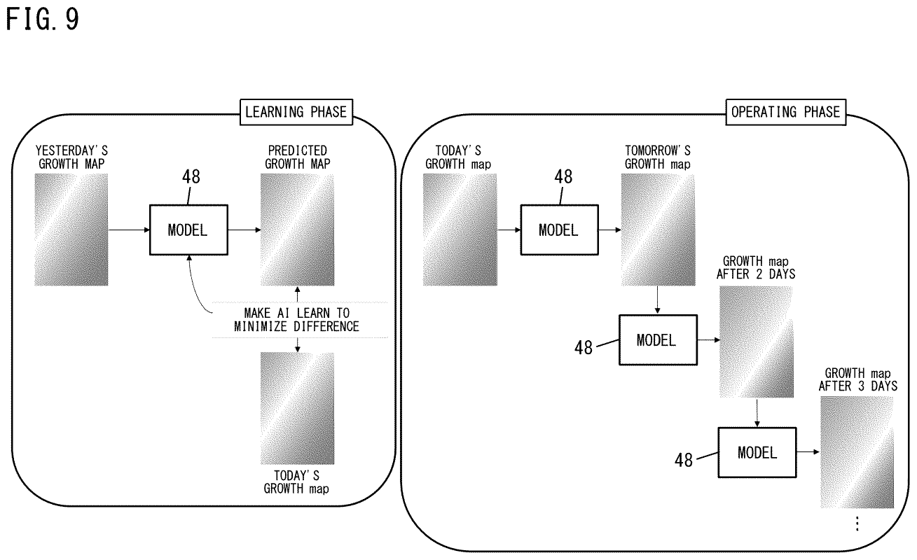

In the above-described example embodiment, the growth data (growth map) Vijk including the growth degree Gk in a relatively near future (for example, after one day) may be predicted by the model 48 (see FIG. 9) that is a learning device capable of machine learning.

The model 48 is a type of the program 47 stored in the storage 42, and may employ, for example, a neural network including at least one hidden layer between an input layer and an output layer.

FIG. 9 is an explanatory diagram illustrating an example of a prediction method of the future growth data Vijk.

In FIG. 9, the model 48 includes a learning device having the growth degree Gk of yesterday at the planting position (Xi, Yj) as input data (teacher data) and the growth degree Gk of today at the planting position (Xi, Yj) as output data. The training of the model 48 is performed by adjusting the weighting between the nodes in the model 48 so that the difference between the input data and the output data is minimized (learning phase).

When the accuracy of the model 48 is confirmed by the training for the predetermined period, the model 48 is used for the prediction processing of the growth data Vijk of the next day (operating phase).

Specifically, today's growth data Vijk is input to the model 48, and tomorrow's growth data Vijk is output from the model 48. Similarly, the tomorrow's growth data Vijk is input to the model 48, and the growth data Vijk after two days is output from the model 48. The same applies to prediction after three days.

### Modification 2: Labor Saving of Growth Data

In the above-described example embodiment, growth data (growth map) Vijk may be sampled sparsely, and data obtained by performing predetermined processing such as predetermined total variation (TV) regularization on the sampling data may be used as the growth data Vijk used for the selection processing and the like.

In this way, since the number of samples of the source data is small, there is an advantage that the storage capacity in the storage 42 can be reduced as compared with the case of storing the growth data Vijk including the growth degrees Vk of all the planting positions (Xi, Yj).

The example embodiments and modifications disclosed herein is illustrative in all respects and is not restrictive. The scope of rights of the present invention is not limited to the above-described example embodiments and modifications, and includes all additional modifications within the scope equivalent to the configurations described in the claims.

In the above-described example embodiments, the “work subject” for harvesting the grapes 3 is not limited to the human worker 1, and may be a harvesting robot that automatically travels in the vineyard Au. In this case, the harvest of the grapes 3 by the harvesting robot may be either a remote operation or an automatic harvest.

In the above-described example embodiment, the crop 3 is not limited to the grape 3 as long as the yield can be almost accurately expected with respect to the planting position (Xi, Yj).

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An information processing device comprising:
a storage to store value data representing a crop value of a crop for each planting position; and
a controller configured or programmed to execute selection processing of a harvest range on a basis of the value data; wherein
the selection processing includes:
processing of calculating a harvestable area in which a work subject is allowed to execute harvesting in a predetermined period; and
processing of allocating the harvestable area to the planting position where the crop value is equal to or more than a predetermined threshold.

2. The information processing device according to claim 1, wherein the selection processing includes processing of preferentially allocating the harvestable area to the planting position having a high crop value.

3. The information processing device according to claim 1, wherein the selection processing includes processing of arbitrarily selecting a first planting position as the planting position, and preferentially allocating second and subsequent planting positions that are close in distance from the first planting position.

4. The information processing device according to claim 1, wherein the selection processing includes processing of calculating the harvestable area on a basis of a harvest time during which the work subject is allowed to execute harvesting, harvest efficiency of the work subject, and a total number of the work subjects.

5. The information processing device according to claim 1, wherein
the storage is configured to store growth data indicating a growth degree of the crop for each of the planting positions; and
the controller is configured or programmed to execute processing of converting the growth data into the value data.

6. The information processing device according to claim 1, wherein the controller is configured or programmed to output the value data including the harvest range that has been selected as a selection result.

7. The information processing device according to claim 1, wherein the controller is configured or programmed to execute calculation processing of an achievement characteristic indicating a relationship between a high value yield and a harvest achievement; wherein
High value yield is a yield when harvest work is performed in descending order of crop values; and
Harvest achievement is a cumulative value of crop values when harvest work is performed in descending order of crop values.

8. The information processing device according to claim 7, wherein
the controller is configured or programmed to calculate:
a harvestable amount that is a yield of the crop that is achievable during the predetermined period; and
a possible harvest achievement that is the harvest achievement corresponding to the harvestable amount on a basis of the harvestable amount and the achievement characteristic.

9. The information processing device according to claim 7, wherein the controller is configured or programmed to acquire a target harvest achievement that is the harvest achievement desired by a user, and calculate a target yield that is the high value yield corresponding to the target harvest achievement on a basis of the target harvest achievement and the achievement characteristic.

10. A selection method of a harvest range executed by an information processing device, the selection method comprising:
storing value data representing a crop value of a crop for each planting position; and
executing selection processing of the harvest range on a basis of the value data; wherein
the selection processing includes:
processing of calculating a harvestable area in which a work subject is allowed to execute harvesting in a predetermined period; and
processing of allocating the harvestable area to the planting position where the crop value is equal to or more than a predetermined threshold.

11. A non-transitory computer readable storage medium storing a computer program for causing a computer to function as an information processing device, the computer program causing the computer to function as:
a storage to store value data representing a crop value of a crop for each planting position; and
a controller configured or programmed to execute selection processing of a harvest range on a basis of the value data; wherein
the selection processing includes:
processing of calculating a harvestable area in which a work subject is allowed to execute harvesting in a predetermined period; and
processing of allocating the harvestable area to the planting position where the crop value is equal to or more than a predetermined threshold.
